(19) United States
(12) Patent Application Publication
(10) Pub. No.: US 2019/0179183 A1
(43) Pub. Date: Jun. 13, 2019

(54) DISPLAY PANEL AND DISPLAY DEVICE

(71) Applicants: HKC Corporation Limited, Shenzhen (CN); Chongqing HKC Optoelectronics Technology Co., Ltd., Chongqing (CN)

(72) Inventor: YU-JEN CHEN, Chongqing (CN)

(21) Appl. No.: 16/276,682

(22) Filed: Feb. 15, 2019

Related U.S. Application Data
(63) Continuation-in-part of application No. PCT/CN2017/081615, filed on Apr. 24, 2017.

(30) Foreign Application Priority Data
Apr. 21, 2017 (CN) 2017102688861

(51) Int. Cl. G02F 1/1339; G02F 1/1362

(52) U.S. Cl. CPC G02F 1/1339; G02F 2001/136222; G02F 1/136209

(57) ABSTRACT

The present application discloses a display panel and a display device. The display panel includes first substrate and second substrate disposed opposite to the first substrate, where the first substrate includes a first underlay substrate and a first conducting part, photo spacers and active switches disposed on the first underlay substrate, the first conducting part includes a sub-conducting part, a conducting body is disposed on the photo spacer and the conducting body is bonded with the sub-conducting part. The second substrates are disposed opposite to the first substrates. The photo spacer is disposed between the first substrates and the second substrates. Each second substrate includes a second conducting part. The conducting body is bonded with the second conducting part when the first substrates and the second substrates are laminated. The sub-conducting part and the second conducting part are conducted through the conducting body.

The present application is a continuation-in-part of application No. PCT/CN2017/081615 filed on Apr. 24, 2017, which claims the benefit of Chinese Patent Application No. CN2017102688861 filed on Apr. 21, 2017, and entitled “DISPLAY PANEL AND DISPLAY DEVICE”. The entire contents of the above applications are hereby incorporated by reference in their entirety.

### TECHNICAL FIELD

The present application relates to the technical field of display, and more particularly to a display panel and a display device.

### BACKGROUND

The statements in this section merely provide background information related to the present application and may not constitute prior art.

Liquid crystal displays have numerous advantages, such as a thin body, power savings, no radiation, etc. and are widely used. Most liquid crystal displays in the market are backlight liquid crystal displays, each including a liquid crystal panel and a backlight module. Working principle of the liquid crystal panel is that: liquid crystals are put in two parallel glass substrates, and a driving voltage is applied to the two glass substrates to control rotation of the liquid crystals, to refract light rays of the backlight module to generate a picture.

Thin film transistor-liquid crystal displays (TFT-LCD) currently maintain a leading status in the display field because of low power consumption, excellent picture quality, high production yield and other properties. Similarly, the TFT-LCD includes a liquid crystal panel and a backlight module. The liquid crystal panel includes a color filter substrate (CF substrate) and a thin film transistor substrate (TFT substrate), and transparent electrodes on relative inner sides of the above substrates. A layer of liquid crystals (LC) is positioned between two substrates. The liquid crystal panel changes a polarized state of light by controlling the direction of the LCs through an electric field, and realizes penetration and obstruction of a light path via a polarized plate, to realize the purpose of display.

In the technology of touching the panel in the liquid crystal panel, the color filter substrate and the array substrate needs to be laminated, so that the photo spacers (PS) on the color filter substrate and the conducting layers on the photo spacers are in contact with specific conducting positions on the array substrate to realize conduction in the positions of the photo spacers for performing signal transmission, the signal of touching was readout by the photo spacer conducting contact part. The specific conducting positions on the array substrate are set correspondingly to the size of the photo spacers. Generally, a plurality of photo spacers are disposed, and correspondingly, multiple specific conducting positions are set. Thus, when the array substrate and the color filter substrate are laminated, the photo spacers and the specific conducting positions are easy to be dislocated. Once dislocation, conduction cannot be performed, signals in the positions cannot be transmitted and a problem of touch failure is formed.

### SUMMARY

The present application is to provide a display panel which can prevent touch failure and ensure normal signal transmission.

In addition, the present application further provides a display device including the above display panel.

The purpose of the present application is achieved through the following technical solution:

According to one aspect of the present application, the present application discloses a display panel which includes: first substrate, where the first substrate includes a first underlay substrate and first conducting parts, photo spacers and active switches disposed on the first underlay substrate, the first conducting part includes a sub-conducting part, a conducting body is disposed on the photo spacer and the conducting body is bonded with the sub-conducting part; second substrate, where the second substrate are disposed opposite to the first substrate, the photo spacer is disposed between the first substrate and the second substrate, the second substrate includes a second conducting part; the conducting body is bonded with the second conducting part when the first substrate and the second substrate are laminated, and the sub-conducting part and the second conducting part are conducted through the conducting body.

Optionally, the second substrate includes a color filter layer, and the second conducting part disposed on the color filter layer. This is a specific mode for arranging the second substrate in the present application. Specifically, the color filter layer is disposed on the second underlay substrate of the second substrate, the second conducting part is disposed on the color filter layer, and the area of the second conducting part is large, and is greatly larger than the touch area of the photo spacers and the second conducting part. Therefore, conduction is easy to realize when the photo spacers and the conducting bodies on the photo spacers when the color filter substrate and the array substrate are laminated and touched with the second conducting parts on the color filter layer, thereby realizing signal transmission and avoiding touch failure.

Optionally, the first substrate further includes chemical resistance layers, and the chemical resistance layer is disposed between the color filter layer and the first conducting part.

Optionally, the chemical resistance layer is made of the passivation layer.

Optionally, the passivation layer includes: at least one of non-alkali glass fiber cloth, glass fiber mat, glass fiber paper, asbestos paper, asbestos cloth, asbestos felt, cellulose paper, cotton cloth, mica products, ceramics, marble and glass.

Optionally, the second conducting parts are continuously disposed on the color filter layer. This is an optional arrangement mode of the second conducting parts in the present application. The second conducting parts are continuously disposed on the color filter layer, so that the second conducting parts are not spacedly disposed. In this way, the photo spacers and the conducting bodies on the photo spacers are touched and bonded with the second conducting parts when the first substrate and the second substrate are laminated, thereby realizing the conduction, to perform signal transmission.

Optionally, the first substrate includes a color filter layer, and the first conducting part is disposed on the color filter layer. This is a specific mode for arranging the first substrate in the present application. Specifically, the color filter layer is disposed on the first underlay substrate of the first substrate, and the first conducting part is disposed on the color filter layer. A surface of the second substrate is not flat and smooth enough because of the arrangement of the color filter layer. However, in the present application, the color filter layer is disposed on the first underlay substrate of the first substrate, so that the surface of the second underlay substrate of the second substrate has no color filter layer and the second underlay substrate of the second substrate is disposed to be flat and smooth. Thus, dislocation is not easy to occur when the first substrate and the second substrate are laminated and touched, thereby facilitating the conduction of the sub-conducting parts of the first conducting part through the photo spacers, the conducting bodies on the photo spacers and the second conducting part.

Optionally, each second substrate includes a black matrix, the black matrix is disposed in each second conducting part, The black matrix plays a role of shading, and the black matrix is disposed in the second conducting part to avoid exposing the black matrix and to further prevent the photo spacers and the conducting bodies on the photo spacers from touching the black matrix, to avoid that the conduction is impossible. In this way, the photo spacers and the conducting bodies on the photo spacers in the present application are easier to touch the second conducting part to realize conduction, to perform signal transmission.

Optionally, the second conducting parts are spacedly disposed.

Optionally, the color filter layer includes white photoresists, the photo spacers are directly disposed on the white photoresist, and the photo spacers and the white photoresist are made of the same material. Because the photo spacers and the white photoresist are made of the same material, in a manufacturing technology, the photo spacers can be manufactured while the white photoresist is manufactured, that is, the white photoresist and the photo spacers can be manufactured in the same manufacturing process, so that the process of the manufacturing technology can be saved and manufacturing efficiency is increased. After the arrangement of the white photoresist and the photo spacers is completed, the first conducting part is directly disposed on the white photoresist, the conducting bodies are directly disposed on the photo spacers, and the sub-conducting parts of the first conducting part are bonded with the conducting bodies to realize a conduction state.

Optionally, a first conducting part is directly disposed on the white photoresist, the conducting body is directly disposed on the photo spacer, and the sub-conducting part of the first conducting part is bonded with the conducting body.

Optionally, the photo spacers is disposed on the sub-conducting part. Because the photo spacers are disposed on the sub-conducting parts in space, a contact effect between the photo spacers and the sub-conducting parts is better and a contact effect between the conducting bodies on the photo spacers and the sub-conducting parts is better. Thus, a conduction effect of the conducting bodies and the sub-conducting parts is better.

Optionally, the conducting body is covered on an outer surface of the photo spacer. Because the conducting body is directly covered on the outer surface of the photo spacer, the contact between the conducting bodies and the sub-conducting parts is more convenient, and the contact between the conducting bodies and the second conducting part is more convenient.

Optionally, a root of the photo spacer is larger than a top of the photo spacer, and a size of the photo spacer is gradually increased from the top to the root. This is a specific structure for arranging the photo spacers, so that the photo spacers have stable structures and good supporting effect.

Optionally, the photo spacer is a cylinder.

According to another aspect of the present application, the present application further discloses a display device which includes the above display panel.

In the prior art, the display panel is easy to be dislocated in the technology of touching the panel, causing that conduction is impossible, signals cannot be transmitted in this position and a problem of touch failure is formed.

In the present application, active switches, the first conducting parts and the photo spacers are disposed on each first substrate, the photo spacer is disposed on the sub-conducting part of the first conducting part and the conducting body is disposed on the photo spacer, so that the photo spacer is directly conducted with the sub-conducting part through the conducting body and then the conducting body and the sub-conducting part on the photo spacer are always in the conduction state. In this way, when the first substrate and the second substrate are laminated and touched, the conducting body on the photo spacer only needs to touch the second conducting part on each second substrate, to ensure that the conducting body and the second conducting part are bonded to realize electrical connection. The sub-conducting part of the first conducting part is conducted with the second conducting part through the conducting body to transmit signals in this position, the signal of touching was readout by the photo spacer conducting contact part. Because of this, the display panel in the present application avoids the problem of touch failure, so that the display panel can normally show and the production efficiency is increased.

### BRIEF DESCRIPTION OF DRAWINGS

The drawings included are used for providing further understanding of embodiments of the present application, constitute part of the description, are used for illustrating implementation manners of the present application, and interpret principles of the present application together with text description. Apparently, the drawings in the following description are merely some embodiments of the present application, and for those of ordinary skill in the art, other drawings can also be obtained according to the drawings without contributing creative labor. In the drawings:

FIG. 1 is a structural schematic diagram of a display panel in the present application.

FIG. 2 is a structural schematic diagram of a display panel in the present application.

FIG. 3 is a structural schematic diagram of a display panel in the present application.

FIG. 4 is a structural schematic diagram of a display panel in an embodiment of the present application.

FIG. 5 is a structural schematic diagram of a display panel in an embodiment of the present application.

FIG. 6 is a structural schematic diagram of a display panel in an embodiment of the present application.

FIG. 7 is a structural schematic diagram of a display panel in an embodiment of the present application.

FIG. 8 is a structural schematic diagram of a display device in an embodiment of the present application.

FIG. 9 is a structural schematic diagram of a display device in an embodiment of the present application.

### DETAILED DESCRIPTION

Concrete structure and function details disclosed herein are only representative and are used for the purpose of describing exemplary embodiments of the present application. However, the present application may be specifically achieved in many alternative forms and shall not be interpreted to be only limited to the embodiments described herein.

It should be understood in the description of the present application that terms such as “central”, “horizontal”, “upper”, “lower”, “left”, “right”, “vertical”, “horizontal”, “top”, “bottom”, “inner”, “outer”, etc. indicate direction or position relationships shown based on the drawings, and are only intended to facilitate the description of the present application and the simplification of the description rather than to indicate or imply that the indicated device or element must have a specific direction or constructed and operated in a specific direction, and therefore, shall not be understood as a limitation to the present application. In addition, the terms such as “first” and “second” are only used for the purpose of description, rather than being understood to indicate or imply relative importance or hint the number of indicated technical features. Thus, the feature limited by “first” and “second” can explicitly or impliedly include one or more features. In the description of the present application, the meaning of “a plurality of” is two or more unless otherwise specified. In addition, the term “include” and any variant are intended to cover non-exclusive inclusion.

It should be noted in the description of the present application that, unless otherwise specifically regulated and defined, terms such as “installation”, “bonded” and “bonding” shall be understood in broad sense, and for example, may refer to fixed bonding or detachable bonding or integral bonding, may refer to mechanical bonding or electrical bonding, and may refer to direct bonding or indirect bonding through an intermediate medium or inner communication of two elements. For those of ordinary skill in the art, the meanings of the above terms in the present application may be understood according to concrete conditions.

The terms used herein are intended to merely describe concrete embodiments, not to limit the exemplary embodiments. Unless otherwise noted clearly in the context, singular forms “one” and “single” used herein are also intended to include plurals. It should also be understood that the terms “comprise” and/or “include” used herein specify the existence of stated features, integers, steps, operation, units and/or assemblies, not excluding the existence or addition of one or more other features, integers, steps, operation, units, assemblies and/or combinations of these.

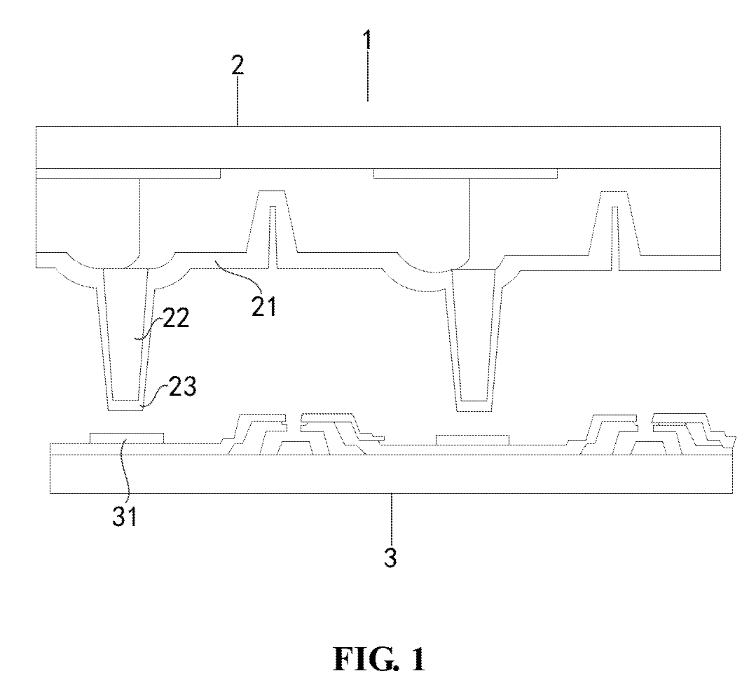

The display panel and the display device of the present application are described below with reference to FIG. 1 to FIG. 9.

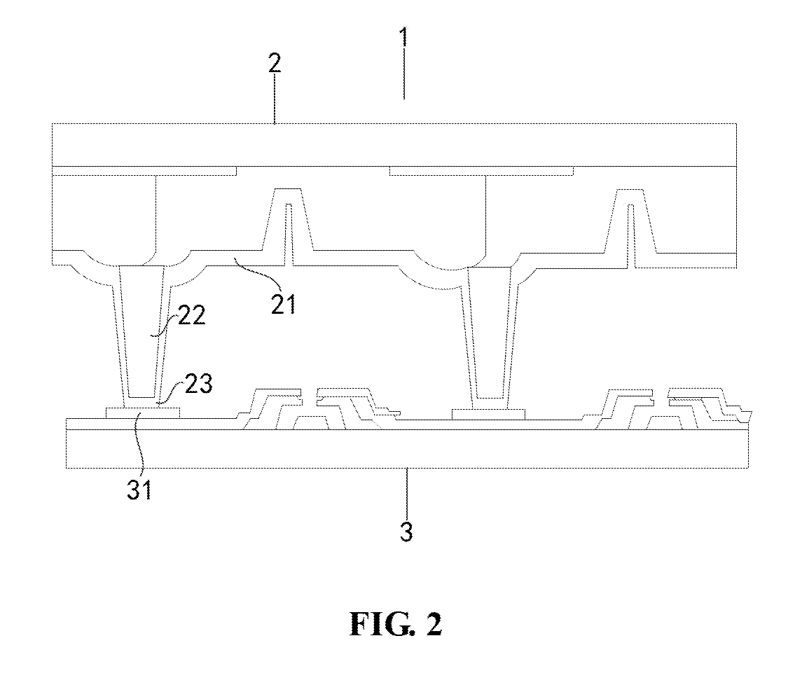

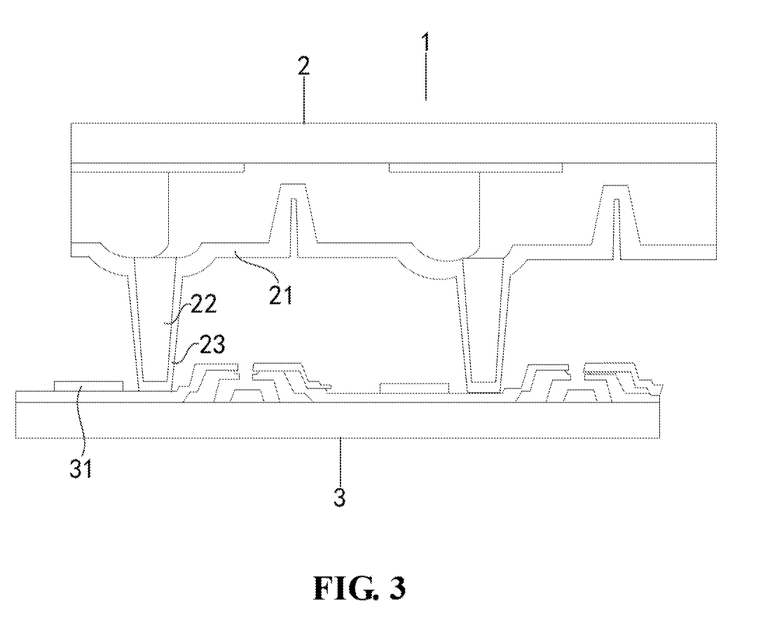

As shown in FIG. 1 to FIG. 3, FIG. 1 is a structural schematic diagram of a display panel designed by an applicant, FIG. 2 is a diagram of a lamination and touched state of the display panel designed by the applicant, and FIG. 3 is a diagram of a lamination state of the display panel designed by the applicant. Specifically, the display panel 1 includes a color filter substrate 2 and an array substrate 3, where a photo spacer 22, a color filter substrate conducting layer 21 and a conducting body 23 are disposed on the color filter substrate 2, the conducting body 23 is disposed on the photo spacer 22 and the conducting body 23 is conducted with the color filter substrate conducting layer 21. A photo spacer conducting contact part 31 is disposed on the array substrate 3. A state before the color filter substrate 2 and the array substrate 3 of the display panel 1 are laminated is shown in FIG. 1, and a state when the color filter substrate 2 and the array substrate 3 are laminated and touched is shown in FIG. 2 and FIG. 3, when the lamination of the color filter substrate 2 and the array substrate 3 is correct, the conducting body 23 on the photo spacer 22 is touched or is bonded with the photo spacer conducting contact part 31, so that the photo spacer conducting contact part 31 and the conducting body 23 are conducted to realize signal transmission in a position of the photo spacer conducting contact part 31, the signal of touching was readout by the photo spacer conducting contact part 31, as shown in FIG. 2 for details. However, because wrong touch between the color filter substrate 2 and the array substrate 3 may be generated in actual production, the conducting body 23 on the photo spacer 22 cannot touch or cannot be bonded with the photo spacer conducting contact part 31 so that the photo spacer conducting contact part 31 and the conducting body 23 cannot be conducted when the color filter substrate 2 and the array substrate 3 are laminated and touched, causing that signal transmission in a position of the photo spacer conducting contact part cannot be realized and touch failure is formed. As shown in FIG. 3 for details.

Therefore, the applicant also designs another technical solution for solving the above technical problem, specifically:

The display panel disclosed in the present application includes:

first substrate, where the first substrate includes a first underlay substrate and first conducting parts, photo spacers and active switches disposed on the first underlay substrate, the first conducting part includes a sub-conducting part, a conducting body is disposed on the photo spacer and the conducting body is bonded with the sub-conducting part,

second substrate, where the second substrate are disposed opposite to the first substrate, the photo spacer is disposed between the first substrate and the second substrate, the second substrate includes a second conducting part, the conducting body is bonded with the second conducting part when the first substrate and the second substrate are laminated and touched, and the sub-conducting part and the second conducting part are conducted through the conducting body.

In the present application, active switches, the first conducting part and the photo spacer are disposed on each first substrate, the photo spacer is disposed on the sub-conducting part of the first conducting part and the conducting body is disposed on the photo spacer, so that the photo spacer is directly conducted with the sub-conducting part through the conducting body and then the conducting body and the sub-conducting part on the photo spacer are always in the conduction state. In this way, when the first substrate and the second substrate are laminated and touched, the conducting body on the photo spacer only needs to touch the second conducting part on each second substrate, to ensure that the conducting body and the second conducting part are bonded to realize electrical connection. The subconducting part of the first conducting part is conducted with the second conducting part through the conducting body, the signals of the second conducting part is transmitting to the conducting body of the photo spacer to transmit signals in this position, the signal of touching was readout by the photo spacer conducting contact part. Because of this, the display panel in the present application avoids the problem of touch failure, so that the display panel can normally show and the production efficiency is increased.

The display panel in the present application may include any of the following: a twisted nematic (TN) or super twisted nematic (STN) type panel, an in-plane switching (IPS) type panel, a vertical alignment (VA) type panel, a high vertical alignment (HVA) type panel and a curved surface type panel.

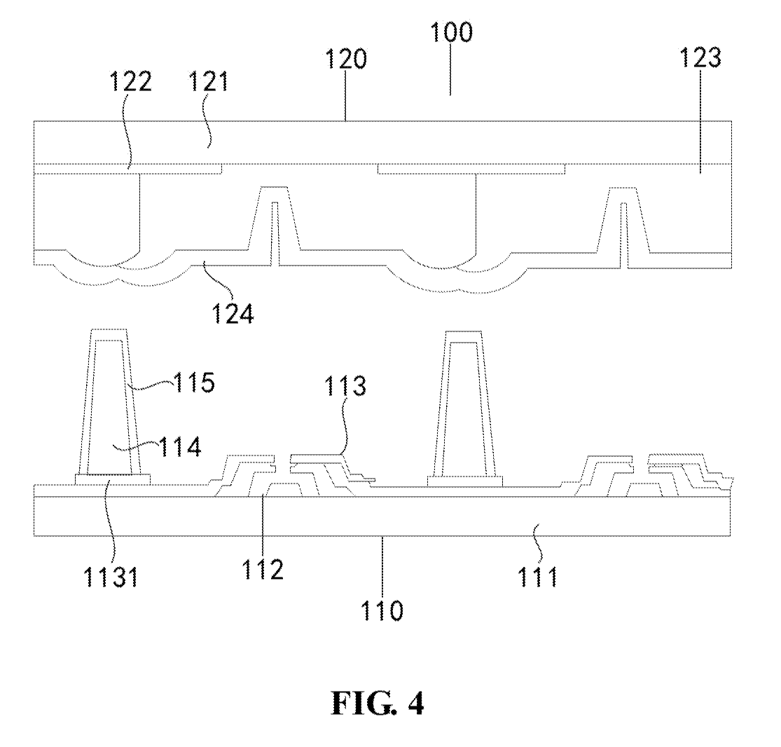

The present application will be further described in detail below in combination with FIG. 4 to FIG. 9 and optional embodiments.

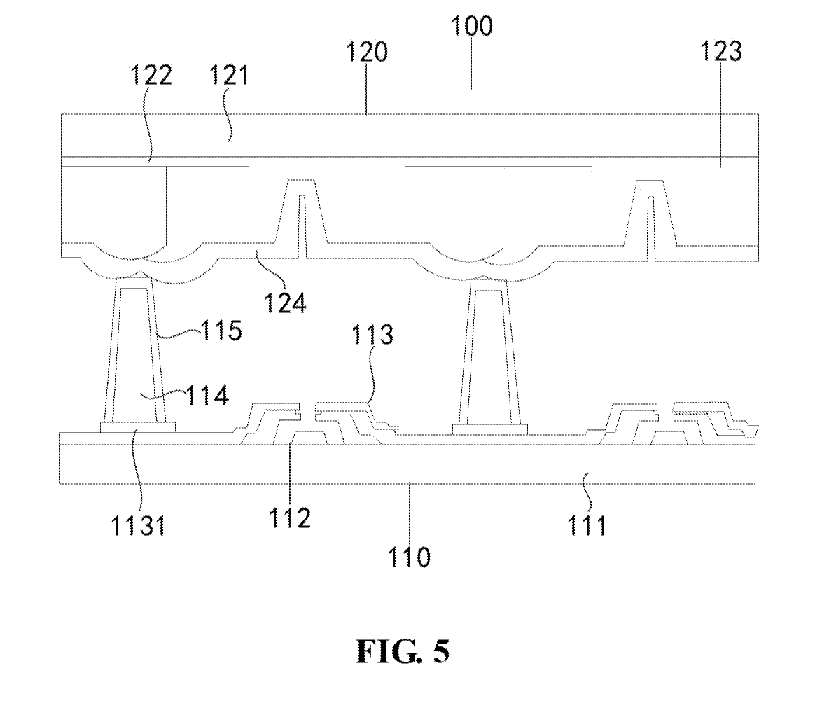

According to an embodiment of the present application, as shown in FIG. 4 and FIG. 5, an embodiment of the present application discloses a display panel 100 which includes a substrate which includes a first substrate 110 and a second substrate 120 which are disposed opposite to each other.

The first substrate 110 includes a first underlay substrate 111 and first conducting parts 113, photo spacers 114 and active switches 112 which are disposed on the first underlay substrate 111, the first conducting part 113 includes a photo space conducting part 1131, a conducting body 115 is disposed on the photo spacer 114 and the conducting body 115 is bonded with the photo space conducting part 1131.

The second substrate 120 includes a second underlay substrate 121, a black matrix 122, a color filter layer 123 and a second conducting part 124, the second conducting part 124 is disposed on the color filter layer 123, the photo spacer 114 is disposed between the first substrate 110 and the second substrate 120, the conducting body 115 is bonded with the second conducting part 124 when the first substrate 110 and the second substrate 120 are laminated, and the sub-conducting part 1131 and the second conducting part 124 are conducted through the conducting body 115.

Specifically, the color filter layer 123 is disposed on the second underlay substrate 121 of the second substrate 120, the second conducting part 124 is disposed on the color filter layer 123, and the area of the second conducting part 124 is large, and is greatly larger than the touch area of the photo spacer 114 and the second conducting part 124. Therefore, conduction is easy to realize when the photo spacer 114 and the conducting body 115 on the photo spacer 114 when the color filter substrate 2 and the array substrate 3 are laminated and touched with the second conducting part 124 on the color filter layer 123, the signals of the second conducting part 124 is transmitting to the conducting body 115 of the photo spacer 114 to transmit signals in this position, the signal of touching was readout by the photo spacer conducting contact part, thereby realizing signal transmission and avoiding touch failure.

Further, the second conducting parts 124 are continuously disposed on the color filter layer 123. This is an optional arrangement mode of the second conducting parts 124 in the embodiment of the present application. Because the second conducting parts 124 are continuously disposed on the color filter layer 123, the second conducting parts are not spacedly disposed. Because of this, the photo spacer 114 and the conducting body 115 on the photo spacer 114 are touched and bonded with the second conducting parts 124 when the first substrate 110 and the second substrate 120 are laminated and touched, thereby realizing the conduction, to perform signal transmission.

The conducting body 115 is covered on the outer surface of the photo spacer 114. Because the conducting body 115 is directly covered on the outer surface of the photo spacer 114, the contact between the conducting body and the sub-conducting part is more convenient, and the contact between the conducting body 115 and the second conducting part 124 is more convenient. Of course, it should be explained that the arrangement of the conducting body in the embodiment of the present application is not limited thereto.

A root of the photo spacer 114 is larger than a top of the photo spacer 114, and a size of the photo spacer 114 is gradually increased from the top to the root. This is a specific structure for arranging the photo spacer, so that the photo spacer has stable structure and good supporting effect. Of course, it should be explained that the arrangement of the photo spacer in the embodiment of the present application is not limited thereto. The photo spacer can also be disposed in other structures. For example: the photo spacer has a cylinder structure, a rectangular structure, etc.

The photo spacer 114 is disposed on the sub-conducting part 1131. Because the photo spacer 114 is disposed on the sub-conducting part 1131 in space, a contact effect between the photo spacer 114 and the sub-conducting part 1131 is better and a contact effect between the conducting body 115 on the photo spacer 114 and the sub-conducting part 1131 is better. Thus, a conduction effect of the conducting body 115 and the sub-conducting part 1131 is better.

The color filter layer 123 includes red photoresists, green photoresists and blue photoresists. However, it should be explained that the color filter layer in the embodiment of the present application is not limited to the red photoresist, the green photoresist and the blue photoresist, and can also include other color photoresists, such as: white photoresists.

This is a specific mode for arranging the first substrate 110 and the second substrate 120 in the embodiment of the present application. It should be explained that a specific arrangement of the first substrate and the second substrate in the present application is not limited thereto.

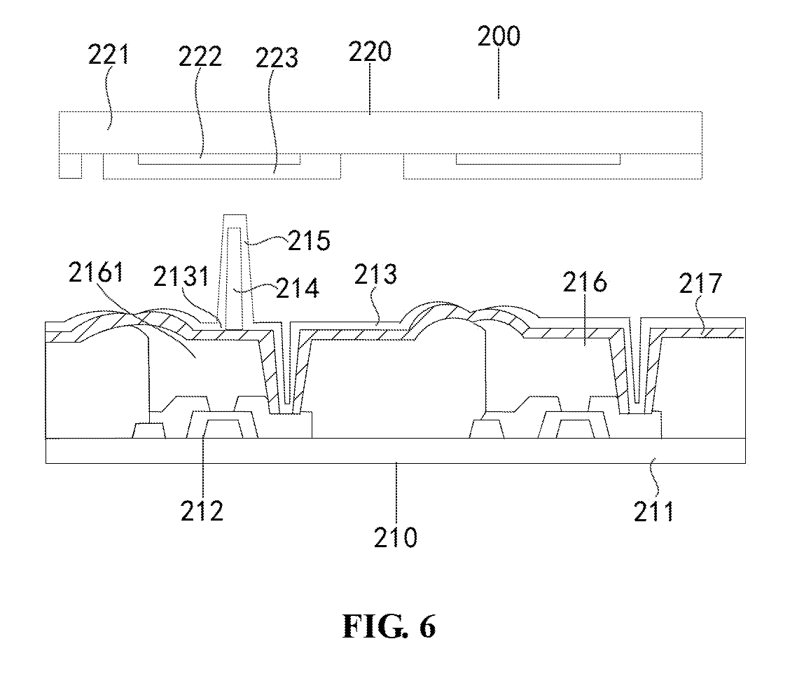

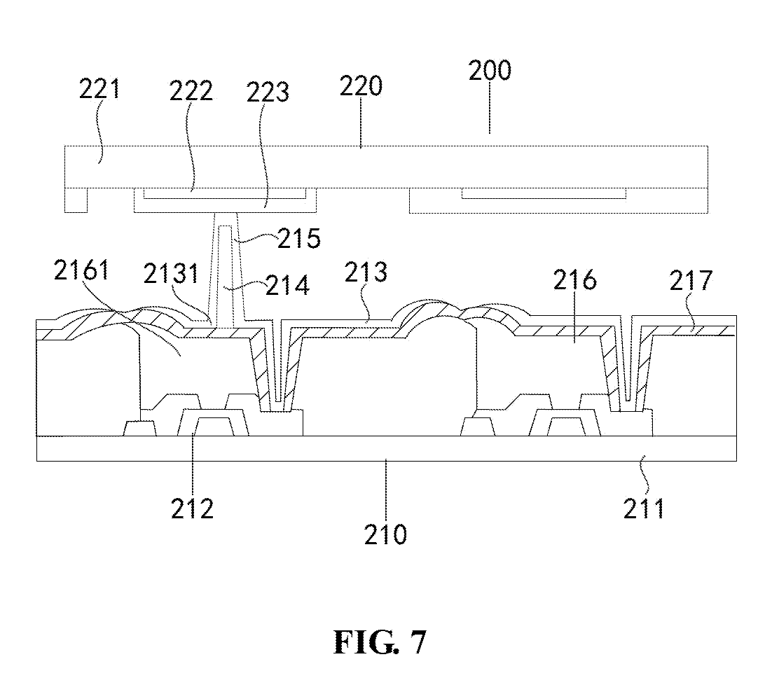

According to an embodiment of the present application, as shown in FIG. 6 and FIG. 7, an embodiment of the present application discloses a display panel 200 which includes a substrate which includes a first substrate 210 and a second substrate 220 which are disposed opposite to each other.

The first substrate 210 includes a first underlay substrate 211 and first conducting parts 213, photo spacers 214, active switches 212 and a color filter layer 216 which are disposed on the first underlay substrate 211, the first conducting part 213 include a sub-conducting part 2131, a conducting body 215 is disposed on the photo spacer 214 and the conducting body 215 is bonded with the sub-conducting part 2131.

Specifically, the first conducting part 213 is disposed on the color filter layer 216. This is a specific mode for arranging the first substrate in the embodiment of the present application. Specifically, the color filter layer 216 is disposed on the first underlay substrate 211 of the first substrate 210, and the first conducting part 213 is disposed on the color filter layer 216. A surface of the second substrate is not flat and smooth enough because of the arrangement of the color filter layer 216. However, in the embodiment of the present application, the color filter layer 216 is disposed on the first underlay substrate 211 of the first substrate 210, so that the surface of the second underlay substrate 221 of the second substrate 220 has no color filter layer and the second underlay substrate 221 of the second substrate 220 is disposed to be flat and smooth. Thus, dislocation is not easy to occur when the first substrate 210 and the second substrate 220 are laminated and touched, thereby facilitating the conduction of the sub-conducting part 2131 of the first conducting part 213 through the photo spacer 214, the conducting body 215 on the photo spacer 214 and the second conducting part 223.

The second substrate 220 include a second underlay substrate 221, a black matrix 222 and a second conducting part 223, the photo space 114 is disposed between the first substrate 110 and the second substrate 120, the conducting body 215 is bonded with the second conducting part 223 when the first substrate 110 and the second substrate 120 are laminated and touched, and the photo space conducting part 2131 and the second conducting part 223 are conducted through the conducting body 215.

Specifically, the black matrix 222 is disposed in the second conducting part 223, each second conducting part 223 is spacedly disposed, the black matrix 222 plays a role of shading, and the black matrix 222 is disposed in the second conducting part 223 to avoid exposing the black matrix 222 and to further prevent the photo spacer 214 and the conducting body 215 on the photo spacer 214 from touching the black matrix 222, to avoid that the conduction is impossible. In this way, the photo spacer 214 and the conducting body 215 on the photo spacer 214 in the embodiment of the present application are easier to touch the second conducting part 223 to realize conduction, to perform signal transmission.

The color filter layer includes red photoresists, green photoresists and blue photoresists. However, it should be explained that the color filter layer 216 in the embodiment of the present application is not limited to the red photoresist, the green photoresist and the blue photoresist, and can also include other photoresists, such as: a white photoresist 2161.

When the color filter layer 216 includes the white photoresist 2161, the photo spacers 214 are directly disposed on the white photoresist 2161, and the photo spacers 214 and the white photoresist 2161 are made of the same material. Because the photo spacer 214 and the white photoresist 2161 are made of the same material, in a manufacturing technology, the photo spacer 214 can be manufactured while the white photoresist 2161 is manufactured, i.e., the white photoresist 2161 and the photo spacer 214 can be manufactured in the same manufacturing process, so that the process of the manufacturing technology can be saved and manufacturing efficiency is increased. After the arrangement of the white photoresist 2161 and the photo spacer 214 is completed, the first conducting part 213 is directly laid on is directly disposed on the white photoresist 2161, the conducting body 215 is directly laid on is directly disposed on the photo spacer 214, and the sub-conducting part 2131 of the first conducting part 213 is bonded with the conducting body 215 to realize a conduction state.

The conducting body 215 is covered on the outer surface of the photo spacer 214. Because the conducting body 215 is directly covered on the outer surface of the photo spacer 214, the contact between the conducting body and the sub-conducting part 2131 is more convenient, and the contact between the conducting body 215 and the second conducting part 223 is more convenient. Of course, it should be explained that the arrangement of the conducting body in the embodiment of the present application is not limited thereto.

A root of the photo spacer 214 is larger than a top of the photo spacer 214, and a size of the photo spacer 214 is gradually increased from the top to the root. This is a specific structure for arranging the photo spacer, so that the photo spacer has stable structure and good supporting effect. Of course, it should be explained that the arrangement of the photo spacer in the embodiment of the present application is not limited thereto. The photo spacer can also be disposed in other structures. For example: the photo spacer has a cylinder structure, a rectangular structure, etc.

Further, the first substrate 110 further includes chemical resistance layers 217, and the chemical resistance layer 217 disposed between the color filter layer 216 and the first conducting part 213; and the chemical resistance layer 217 is made of the passivation layer. The passivation layer has good chemical resistance and includes but not limited to: non-alkali glass fiber cloth, glass fiber mat, glass fiber paper, asbestos paper, asbestos cloth, asbestos felt, cellulose paper, cotton cloth, mica products, ceramics, marble and glass. It should be explained that the chemical resistance layer in the embodiment of the present application can also be made of other materials. For example, the second chemical resistance layer is made of the organic layer, and the organic layer includes but not limited to lac, resin, rubber, cotton yarn, paper, hemp, natural silk and artificial silk.

This is a specific mode for arranging the first substrate 210 and the second substrate 220 in the embodiment of the present application. It should be explained that a specific arrangement of the first substrate and the second substrate in the present application is not limited thereto.

Two specific illustrations for arranging the display panel in the present application are described above. It should be explained that the structure of the display panel in the present application is not limited thereto. Other structures can also be adopted.

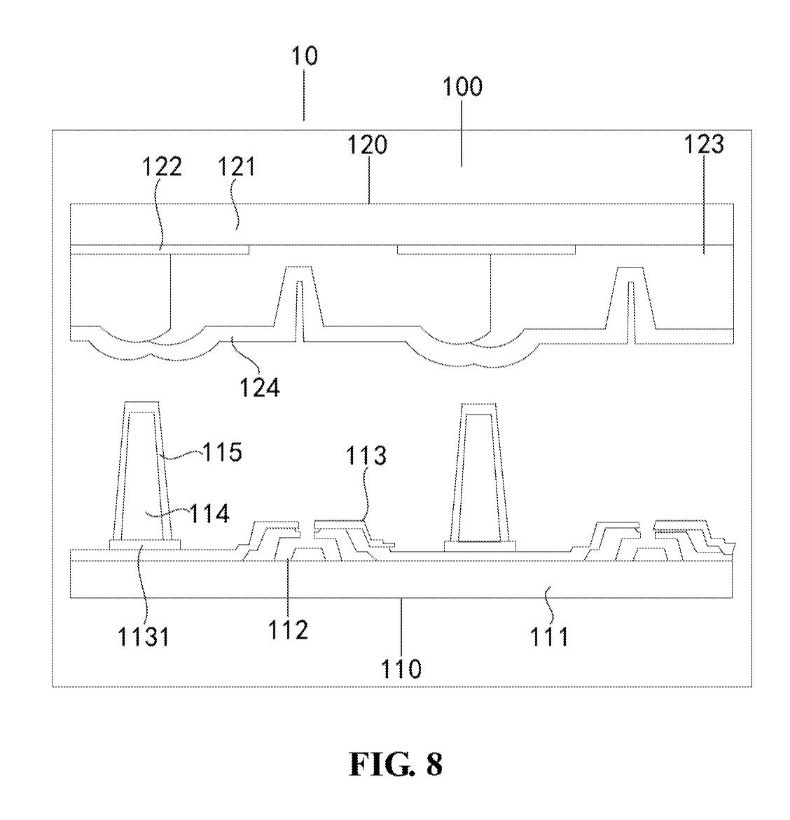

According to an embodiment of the present application, as shown in FIG. 8, an embodiment of the present application further discloses a display device 10 which includes the display panel 100. The display device 10 may be a liquid crystal display or an OLED display. When the display device 10 in the embodiment of the present application is the liquid crystal display, the liquid crystal display includes a backlight module. The backlight module may be used as a light source used for supplying sufficient brightness and uniformly distributed light sources. The backlight module in the present embodiment may be a front-light type, or a backlight type. It should be noted that the backlight module in the present embodiment is not limited thereto. The display panel 100 in the display device in the present embodiment is just a specific structure of the present embodiment. See FIGAs shown in FIG. 4 and FIG. 5 and corresponding embodiments for details. The display panel is not described herein in detail. However, it should be explained that the structure of the display panel 100 in the display device of the present embodiment is not limited thereto.

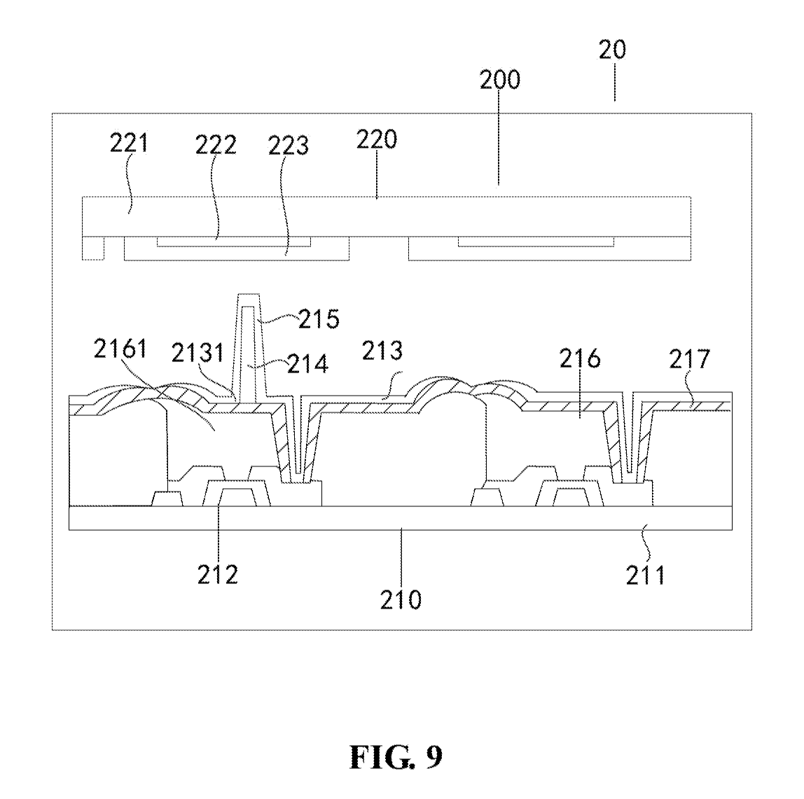

According to an embodiment of the present application, as shown in FIG. 9, an embodiment of the present application further discloses a display device 20 which includes the display panel 200. The display device 20 may be a liquid crystal display or an OLED display. When the display device 20 in the embodiment of the present application is the liquid crystal display, the liquid crystal display includes a backlight module. The backlight module may be used as a light source used for supplying sufficient brightness and uniformly distributed light sources. The backlight module in the present embodiment may be a front-light type, or a backlight type. It should be noted that the backlight module in the present embodiment is not limited thereto. The display panel 200 in the display device in the present embodiment is just a specific structure of the present embodiment. See FIGAs shown in FIG. 6 and FIG. 7 and corresponding embodiments for details. The display panel is not described herein in detail. However, it should be explained that the structure of the display panel 200 in the display device of the present embodiment is not limited thereto.

The above contents are further detailed descriptions of the present application in combination with specific optional embodiments. However, the concrete implementation of the present application shall not be considered to be only limited to these descriptions. For those of ordinary skill in the art to which the present application belongs, several simple deductions or replacements may be made without departing from the conception of the present application, all of which shall be considered to belong to the protection scope of the present application.

What is claimed is:

1. A display panel, comprising:
first substrate, wherein the first substrate comprises a first underlay substrate and first conducting parts, photo spacers and active switches disposed on the first underlay substrate, the first conducting part comprises a sub-conducting part; a conducting body is disposed on the photo spacer and the conducting body is bonded with the sub-conducting part;
second substrate, wherein the second substrate is disposed opposite to the first substrate, the photo spacer is disposed between the first substrate and the second substrate, the second substrate comprises a second conducting part; the conducting body is bonded with the second conducting part when the first substrate and the second substrate are laminated and touched, and the sub-conducting part and the second conducting part are conducted through the conducting body; the second substrate comprises a color filter layer, the second conducting part is disposed on the color filter layer, the second conducting part is continuously disposed on the color filter layer, and the photo spacer is disposed on the sub-conducting part, a size of the photo spacer is gradually increased from the top to the root.

2. A display panel, comprising:
first substrate, wherein the first substrate comprises a first underlay substrate and a first conducting part, photo spacers and active switches disposed on the first underlay substrate, the first conducting part comprises a sub-conducting part, a conducting body is disposed on the photo spacer and the conducting body is bonded with the sub-conducting part; and
second substrate, wherein the second substrate are disposed opposite to the first substrate, the photo spacer is disposed between the first substrate and the second substrate, the second substrate comprises a second conducting part, the conducting body is bonded with the second conducting part when the first substrate and the second substrate are laminated and touched, and the sub-conducting part and the second conducting part are conducted through the conducting body.

3. The display panel according to claim 2, wherein the second substrate comprises a color filter layer, and the second conducting part is disposed on the color filter layer.

4. The display panel according to claim 3, wherein the first substrate further comprises chemical resistance layers, and the chemical resistance layer is disposed between the color filter layer and the first conducting part.

5. The display panel according to claim 4, wherein the chemical resistance layer is made of the passivation layer.

6. The display panel according to claim 5, wherein the passivation layer comprises at least one of non-alkali glass fiber cloth, glass fiber mat, glass fiber paper, asbestos paper, asbestos cloth, asbestos felt, cellulose paper, cotton cloth, mica products, ceramics, marble and glass.

7. The display panel according to claim 3, wherein the second conducting parts are continuously disposed on the color filter layer.

8. The display panel according to claim 2, wherein the first substrate comprises a color filter layer, wherein the color filter layer is disposed on the first underlay substrate, and the first conducting part is disposed on the color filter layer.

9. The display panel according to claim 8, wherein the second substrate comprises a black matrix, the black matrix is disposed in each second conducting part.

10. The display panel according to claim 9, wherein the second conducting parts are spacedly disposed.

11. The display panel according to claim 8, wherein the color filter layer comprises white photoresists, the photo spacers are directly disposed on the white photoresist, and the photo spacers and the white photoresist are made of the same material.

12. The display panel according to claim 11, wherein a first conducting part is directly disposed on the white photoresist, the conducting body is directly disposed on the photo spacer, and the sub-conducting part of the first conducting part is bonded with the conducting body.

13. The display panel according to claim 3, wherein the photo spacer is disposed on the sub-conducting part.

14. The display panel according to claim 2, wherein the conducting body is covered on an outer surface of the photo spacer.

15. The display panel according to claim 2, wherein a root of the photo spacer is larger than a top of the photo spacer; and a size of the photo spacer is gradually increased from the top to the root.

16. The display panel according to claim 2, wherein the photo spacer is a cylinder.

17. A display device, comprising a backlight module and the display panel, wherein the display panel comprises first substrate, the first substrate comprises a first underlay substrate and first conducting parts, photo spacers and active switches disposed on the first underlay substrate, the first conducting part comprises a sub-conducting part, a conducting body is disposed on the photo spacer and the conducting body is bonded with the sub-conducting part; and
second substrate, wherein the second substrate is disposed opposite to the first substrate, the photo spacer is disposed between the first substrate and the second substrate, the second substrate comprises a second conducting part; the conducting body is bonded with the second conducting part when the first substrate and the second substrate are laminated, and the sub-conducting part and the second conducting part are conducted through the conducting body.
